(19) United States
(12) Patent Application Publication
(10) Pub. No.: US 2021/0044015 A1
(43) Pub. Date: Feb. 11, 2021

(54) ARTIFICALLY-STRUCTURED MATERIALS WITH ENGINEERED FREQUENCY DISPERSION

(71) Applicant: Elwha LLC, Bellevue, WA (US)

(72) Inventor: Yaroslav A. Urzhumov, Bellevue, WA (US)

(21) Appl. No.: 16/776,226

(22) Filed: Jan. 29, 2020

Related U.S. Application Data
(60) Provisional application No. 62/883,791, filed on Aug. 7, 2019.

(51) Int. Cl. H01Q 3/01; G06N 3/02; G06N 20/10; G06F 9/445

(52) U.S. Cl. CPC H01Q 3/01; G06N 3/02; G06Q 50/04; G06F 9/44505; G06N 20/10

(57) ABSTRACT

According to various embodiments, systems and methods for providing engineered frequency dispersion for a dynamic wave-processing device across a set of operational frequencies. A set of operational frequencies for a dynamic-wave processing device can be selected. The wave-processing device can comprise, at least in part, a metamaterial with a static structure. Physical design parameters for the static structure of the metamaterial of the dynamic-wave processing device can be selected to dynamically enable a specific set of functional parameters for the metamaterial across the set of operational frequencies.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

This application claims priority to U.S. Provisional Patent Application No. 62/883,791 to Yaroslav A. Urzhumov, titled METAMATERIALS WITH ENGINEERED FREQUENCY DISPERSION, and filed Aug. 7, 2019, the entire disclosure of which is hereby incorporated herein by this reference.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc., applications of such applications are also incorporated by reference, including any priority claims made in those applications and any material incorporated by reference, to the extent such subject matter is not inconsistent herewith.

### TECHNICAL FIELD

The present disclosure generally relates to engineered frequency dispersion for a dynamic wave-processing device across a set of operational frequencies, and more particularly, to engineering a dynamic wave-processing device to enable a specific set of functional parameters across a set of operational frequencies by selecting physical parameters of a static structure as part of a metamaterial of the dynamic wave-processing device.

### BACKGROUND

Devices that incorporate artificially-structured materials have been developed for transmitting and receiving signals. Specifically, wave-processing devices that incorporate artificially-structured materials have been developed for manipulating wave fields in both fluids and solids. In operation, the wave-processing devices can be controlled to achieve various output field profiles as part of manipulating the corresponding wave fields. Typically, a large number of electronic components, e.g. distributed electronic components, are integrated with or integrated as part of the wave-processing devices to control the wave-processing devices in achieving the various output field profiles. However, utilizing such a large number of electronic components for controlling operation of the wave-processing devices presents a number of issues. Specifically, using a large number of electronic components to switch between various beam patterns can consume large amounts of resources, e.g. computational resources, in actually operating the wave-processing device to switch between the various beam patterns. Further, using a large number of electronic components to switch between various beam patterns can slow down response time of the wave-processing device in switching between the various beam patterns. Additionally, incorporating a large number of electronic components with or into a dynamic wave-processing device can increase fabrication costs, including hardware fabrication costs, of the dynamic wave-processing device.

### SUMMARY

According to various embodiments, a method can include selecting a set of operational frequencies for a dynamic wave-processing device. The dynamic wave-processing device can comprise, at least in part, a metamaterial with a static structure. The method can also include selecting physical design parameters for the static structure of the metamaterial as part of the dynamic wave-processing device. The physical design parameters can be selected to dynamically enable a specific set of functional parameters for the metamaterial across the set of operational frequencies.

In various embodiments, an apparatus includes a dynamic wave-processing device having a specific set of functional parameters. The specific set of functional parameters can correspond to a set of operational frequencies of the dynamic wave-processing device that are dynamically enabled through a metamaterial with a static structure of the dynamic wave-processing device within the set of operational frequencies. The set of functional parameters can be enabled in the dynamic wave-processing device based on physical design parameters for the static structure of the metamaterial. The physical design parameters for the static structure of the metamaterial can be specifically selected for enabling the set of functional parameters at the dynamic wave-processing device.

In certain embodiments, a method can include providing a dynamic wave-processing device having a specific set of functional parameters corresponding to a set of operational frequencies of the dynamic wave-processing device. The specific set of functional parameters can be dynamically enabled within the set of operational frequencies at the dynamic wave-processing device through a metamaterial with a static structure of the dynamic wave-processing device. The set of functional parameters can be enabled in the dynamic wave-processing device based on physical design parameters for the static structure of the metamaterial that are specifically selected for enabling the set of functional parameters. The method can also include controlling operation of the dynamic wave-processing device within the set of operational frequencies to selected one or more specific functional parameters of the set of functional parameters.

### BRIEF DESCRIPTION OF THE DRAWINGS

FIG. 1 illustrates an example environment for providing engineered frequency dispersion in manipulating wave fields through a dynamic wave-processing device.

FIG. 2 illustrates an example dynamic wave-processing device.

FIG. 3 is a flowchart of an example method of selecting physical design parameters for a dynamic wave-processing device to dynamically enable a set of functional parameters at the device.

FIG. 4 is a flowchart of an example method of controlling a dynamic wave-processing device to select one or more specific functional parameters dynamically enabled at the dynamic wave-processing device.

FIG. 5 is a cross-sectional view of an artificially-structured material of a dynamic wave-processing device.

FIG. 6 shows an example output field profile created through the artificially-structured material shown in FIG. 5 using one specific frequency of the input signal.

FIG. 7 shows another example output field profile created through the artificially-structured material shown in FIG. 5 using another specific frequency of the input signal, different from the frequency used in FIG. 6.

### DETAILED DESCRIPTION

The subject disclosure describes improved systems and methods for providing engineered frequency dispersion for a dynamic wave-processing device across a set of operational frequencies. Specifically, the subject disclosure describes improved systems and methods for engineering a dynamic wave-processing device to enable a specific set of functional parameters across a set of operational frequencies by selecting physical design parameters of a static structure as part of an artificially-structured material of the dynamic wave-processing device. While certain applications are discussed in greater detail herein, such discussion is for purposes of explanation, not limitation.

In various embodiments, the subject matter described herein can be implemented using artificially-structured materials. Generally speaking, artificially-structured materials are materials whose electromagnetic or acoustic properties are derived from their structural configurations, rather than or in addition to their material composition.

In some embodiments, the artificially-structured materials include metamaterials/metamaterial-based structures. Metamaterials generally feature subwavelength elements, i.e. structural elements with portions having spatial length scales smaller than an operating wavelength of the metamaterial, and the subwavelength elements have a collective response to waves or radiation that corresponds to an effective continuous medium response. For example, in the case of electromagnetic metamaterials, the collective response may be characterized by an effective permittivity, an effective permeability, an effective magnetoelectric coefficient, or any combination thereof. For example, the electromagnetic radiation may induce charges and/or currents in the subwavelength elements, whereby the subwavelength elements acquire nonzero electric and/or magnetic dipole moments. Where the electric component of the electromagnetic radiation induces electric dipole moments, the metamaterial has an effective permittivity; where the magnetic component of the electromagnetic radiation induces magnetic dipole moments, the metamaterial has an effective permeability; and where the electric (magnetic) component induces magnetic (electric) dipole moments (as in a chiral metamaterial), the metamaterial has an effective magnetoelectric coefficient. Some metamaterials provide an artificial magnetic response; for example, split-ring resonators (SRRs)—or other LC or plasmonic resonators—built from nonmagnetic conductors can exhibit an effective magnetic permeability (c.f. J. B. Pendry et al, “Magnetism from conductors and enhanced nonlinear phenomena,” IEEE Trans. Micro. Theo. Tech. 47, 2075 (1999), herein incorporated by reference). Some metamaterials have “hybrid” electromagnetic properties that emerge partially from structural characteristics of the metamaterial, and partially from intrinsic properties of the constituent materials. For example, G. Dewar, “A thin wire array and magnetic host structure with n<0,” J. Appl. Phys. 97, 100101 (2005), herein incorporated by reference, describes a metamaterial consisting of a wire array (exhibiting a negative permeability as a consequence of its structure) embedded in a nonconducting ferrimagnetic host medium (exhibiting an intrinsic negative permeability). Metamaterials can be designed and fabricated to exhibit selected permittivities, permeabilities, and/or magnetoelectric coefficients that depend upon material properties of the constituent materials as well as shapes, chiralities, configurations, positions, orientations, and couplings between the subwavelength elements. The selected permittivites, permeabilities, and/or magnetoelectric coefficients can be positive or negative, complex (having loss or gain), anisotropic, variable in space (as in a gradient index lens), variable in time (e.g. in response to an external or feedback signal), variable in frequency (e.g. in the vicinity of a resonant frequency of the metamaterial), or any combination thereof. The selected electromagnetic properties can be provided at wavelengths that range from radio wavelengths to infrared/visible wavelengths; the latter wavelengths are attainable, e.g., with nanostructured materials such as nanorod pairs or nano-fishnet structures (c.f. S. Linden et al, “Photonic metamaterials: Magnetism at optical frequencies,” IEEE J. Select. Top. Quant. Elect. 12, 1097 (2006) and V. Shalaev, “Optical negative-index metamaterials,” Nature Photonics 1, 41 (2007), both herein incorporated by reference). An example of a three-dimensional metamaterial at optical frequencies, an elongated-split-ring “woodpile” structure, is described in M. S. Rill et al, “Photonic metamaterials by direct laser writing and silver chemical vapour deposition,” Nature Materials advance online publication, May 11, 2008, (doi:10.1038/nmat2197).

While many exemplary metamaterials are described as including discrete elements, some implementations of metamaterials may include non-discrete elements or structures. For example, a metamaterial may include elements comprised of sub-elements, where the sub-elements are discrete structures (such as split-ring resonators, etc.), or the metamaterial may include elements that are inclusions, exclusions, layers, or other variations along some continuous structure (e.g. etchings on a substrate). Some examples of layered metamaterials include: a structure consisting of alternating doped/intrinsic semiconductor layers (cf. A. J. Hoffman, “Negative refraction in semiconductor metamaterials,” Nature Materials 6, 946 (2007), herein incorporated by reference), and a structure consisting of alternating metal/dielectric layers (cf. A. Salandrino and N. Engheta, “Far-field subdiffraction optical microscopy using metamaterial crystals: Theory and simulations,” Phys. Rev. B 74, 075103 (2006); and Z. Jacob et al, “Optical hyperlens: Far-field imaging beyond the diffraction limit,” Opt. Exp. 14, 8247 (2006); each of which is herein incorporated by reference). The metamaterial may include extended structures having distributed electromagnetic responses (such as distributed inductive responses, distributed capacitive responses, and distributed inductive-capacitive responses). Examples include structures consisting of loaded and/or interconnected transmission lines (such as microstrips and striplines), artificial ground plane structures (such as artificial perfect magnetic conductor (PMC) surfaces and electromagnetic band gap (EGB) surfaces), and interconnected/extended nanostructures (nano-fishnets, elongated SRR woodpiles, etc.).

While artificially-structured materials are described with reference to electromagnetic waves of energy, in various embodiments artificially-structured materials described herein can be configured to process or otherwise interact with other applicable waves of energy. For example, artificially-structured materials described herein can process acoustic waves of energy.

Some of the infrastructure that can be used with embodiments disclosed herein is already available, such as general-purpose computers, RF antennas, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor need the steps be executed only once.

As described previously, devices that incorporate artificially-structured materials have been developed for transmitting and receiving signals. Specifically, wave-processing devices that incorporate artificially-structured materials have been developed for manipulating wave fields in both fluids and solids. In operation, the wave-processing devices can be controlled to achieve various beam patterns as part of manipulating the corresponding wave fields. Typically, a large number of electronic components, e.g. distributed electronic components, are integrated with or integrated as part of the wave-processing devices to control the wave-processing devices in achieving the various beam patterns. However, utilizing such a large number of electronic components for controlling operation of the wave-processing devices presents a number of issues. Specifically, using a large number of electronic components to switch between various beam patterns can consume large amounts of resources, e.g. computational resources, in actually operating the wave-processing device to switch between the various beam patterns. Further, using a large number of electronic components to switch between various beam patterns can slow down response time of the wave-processing device in switching between the various beam patterns. Additionally, incorporating a large number of electronic components with or into a dynamic wave-processing device can increase fabrication costs, including hardware fabrication costs, of the dynamic wave-processing device.

The present includes systems and methods for solving these problems/discrepancies. Specifically, a method can include selecting a set of operational frequencies for a dynamic wave-processing device. The dynamic wave-processing device can comprise, at least in part, a metamaterial with a static structure. The method can also include selecting physical design parameters for the static structure of the metamaterial as part of the dynamic wave-processing device. The physical design parameters can be selected to dynamically enable a specific set of functional parameters for the metamaterial across the set of operational frequencies.

Further, an apparatus includes a dynamic wave-processing device having a specific set of functional parameters. The specific set of functional parameters can correspond to a set of operational frequencies of the dynamic wave-processing device that are dynamically enabled through a metamaterial with a static structure of the dynamic wave-processing device within the set of operational frequencies. The set of functional parameters can be enabled in the dynamic wave-processing device based on physical design parameters for the static structure of the metamaterial. The physical design parameters for the static structure of the metamaterial can be specifically selected for enabling the set of functional parameters at the dynamic wave-processing device.

Additionally, a method can include providing a dynamic wave-processing device having a specific set of functional parameters corresponding to a set of operational frequencies of the dynamic wave-processing device. The specific set of functional parameters can be dynamically enabled within the set of operational frequencies at the dynamic wave-processing device through a metamaterial with a static structure of the dynamic wave-processing device. The set of functional parameters can be enabled at the dynamic wave-processing device based on physical design parameters for the static structure of the metamaterial that are specifically selected for enabling the set of functional parameters. The method can also include controlling operation of the dynamic wave-processing device within the set of operational frequencies to selected one or more specific functional parameters of the set of functional parameters.

In various embodiments, a dynamic wave-processing device can be integrated with multi-holographic metamaterials (MHMs) that store a plurality of different volumetric holograms. The dynamic wave-processing device can lack any distributed electronic components, yet offer dynamic functionality using only a few, or as little as one, electronic components such as wave sources (including transducers), switches, attenuators, amplifiers, time-delay lines or phase shifters. Accordingly, costs, e.g. fabrication costs, associated with the dynamic wave-processing device can be switched from hardware aspects to computation aspects of the dynamic-wave processing device.

In certain embodiments, MHMs are extended into the frequency domain, with the different holograms being encoded at different frequencies. This can allow the retrieval of the different holograms without operating a large number of electronic components at the dynamic-wave processing device. In turn, ultra-rapid electronic switching (discrete or quasi-continuous) between the different beam patterns can be achieved by adjusting the carrier frequency generated by the field source(s).

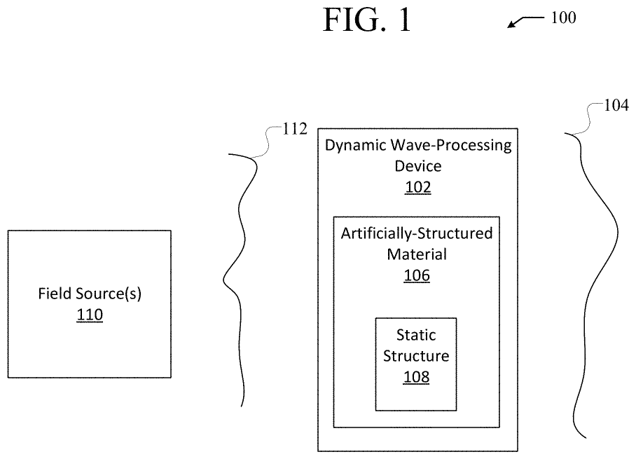

FIG. 1 illustrates an example environment 100 for providing engineered frequency dispersion in manipulating wave fields through a dynamic wave-processing device. The example environment 100 includes a dynamic wave-processing device 102. The dynamic wave-processing device 102 functions to manipulate wave fields to create an output field profile 104. Specifically and as will be discussed in greater detail later, the dynamic wave-processing device 102 can manipulate input waves to generate the output field profile 104. The output field profile 104 can be formed by manipulating a single wave or a plurality of waves. Further, while only a single output field profile 104 is shown in the example environment 100 in FIG. 1, the dynamic wave-processing device 102 can generate multiple different output field profiles, e.g. either simultaneously or in sequence.

In manipulating a wave field to create the output field profile 104, the dynamic wave-processing device 102 can be an acoustic wave-processing device. Specifically, the dynamic wave-processing device 102 can function as an acoustic wave-processing device by manipulating acoustic waves to create an acoustic output field profile. Further, in manipulating wave field to create the output field profile 104, the dynamic wave-processing device 102 can be an electromagnetic wave-processing device. Specifically, the dynamic wave-processing device 102 can function as an electromagnetic wave-processing device by manipulating electromagnetic waves to create an electromagnetic output field profile. Additionally, in manipulating wave field(s) to create the output field profile 104, the dynamic wave-processing device 102 can be an optical wave-processing device. Specifically, the dynamic wave-processing device 102 can function as an optical wave-processing device by manipulating optical waves to create an optical output field profile.

The dynamic wave-processing device 102 includes an artificially-structured material 106. The artificially-structured material 106 can include an applicable material whose electromagnetic or acoustic properties are derived from their structural configurations, such as the previously described artificially-structured materials. Specifically, the artificially-structured material 106 can include a metamaterial. While reference is made throughout this disclosure to a dynamic wave-processing device that includes a metamaterial, the systems and methods described herein can be implemented using a dynamic wave-processing device that includes an artificially-structured material. Further, while reference is made throughout this disclosure to a metamaterial, the metamaterial can include one type of metamaterial or a plurality of different types of metamaterials. Additionally, while reference is made throughout this disclosure to a metamaterial, as will be discussed in greater detail later, the metamaterial can include two separable parts, e.g. two separable metamaterial components or different types of metamaterials that are configured to perform separate operations during the operation of the dynamic-wave processing device 102.

The artificially-structure material 106 of the dynamic wave-processing device 102 includes a static structure 108. The static structure 108 can include at least a portion of the artificially-structured material 106 that does not change during operation of the dynamic wave-processing device 102. Specifically, the static structure 108 can include a plurality of elements that do not change from a structural perspective during operation of the dynamic wave-processing device 102. An element of the artificially-structured material 106, as used herein, can include a micro-structured element of a plurality of micro-structured elements that are arranged to form the artificially-structured material 106. For example, the static structure 108 can include a three-dimensional volumetric arrangement of micro-structured elements that do not change, with respect to the volumetric arrangement of the elements, during operation of the dynamic wave-processing device. Further, the static structure 108 can include a plurality of elements that are not tuned or otherwise remain unchanged, from an element perspective, during operation of the dynamic wave-processing device 102. For example, the static structure 108 can include a plurality of micro-structured elements whose electromagnetic or acoustic properties remain static during operation of the dynamic wave-processing device 102. In another example, the static structure 108 can include a plurality of elements coupled to power sources that remain unchanged during operation of the dynamic wave-processing device 102.

The static structure 108 in the artificially-structured material 106 can function to manipulate wave fields to create the output field profile 104. Specifically, the static structure 108 can manipulate input waves to generate the output field profile 104. The static structure 108 of the artificially-structured material 106 can function to generate, at least in part, a plurality of different output field profiles through operation of the dynamic wave-processing device 102. The static structure 108 can generate a plurality of different output field profiles while a structure of elements forming the static structure 108 remains unchanged. For example, the static structure 108 can be configured to create a plurality of different output field profiles while the elements forming the static structure 108 remain stationary during operation of the dynamic wave-processing device 102. Further, the static structure 108 can be configured to create a plurality of different output field profiles while individual elements of the static structure 108 remain unchanged or are otherwise not tuned during operation of the dynamic wave-processing device 102. For example, the static structure 108 can be configured to generate a plurality of output field profiles while electromagnetic and/or acoustic properties of elements of the static structure 108 remain unchanged during operation of the dynamic wave-processing device 102.

In utilizing the static structure 108 to generate different output field profiles, the dynamic wave-processing device 102 can generate the different field profiles using a few or as little as one electronic component. Examples of electronic components include wave sources, e.g. transducers, switches, time-delay lines, and phase shifters. Specifically, as the static structure 108 can remain static in creating the different output field profiles, the dynamic wave-processing device 102 can generate the different output field profiles using fewer electronic components, e.g. as little as one electronic component, integrated as part of the dynamic wave-processing device 102. Fewer electronic components, when discussed with respect to the dynamic wave-processing device 102, can include fewer electronic components when compared to devices that tune individual artificially-structured material elements to create various output field profiles. In turn, this can simplify control of the dynamic wave-processing device 102 in creating various different output field profiles. Additionally, this can result in faster switching between the different output field profiles during operation of the dynamic wave-processing device.

The static structure 108 can be configured to enable a specific set of functional parameters at the dynamic wave-processing device 102 in order to create a plurality of output field profiles, including the output field profile 104. Functional parameters at the dynamic wave-processing device 102 include applicable parameters related to functioning of the dynamic wave-processing device 102 in manipulating wave fields to generate output field profiles. An output field profile can be specific to one or more functional parameters and corresponding values of the one or more functional parameters. In turn, when the one or more functional parameters and the corresponding values of the parameters are enabled at the dynamic wave-processing device 102, e.g. through the static structure 108, then the dynamic wave-processing device 102 can reproduce the output field profile. For example, if a specific focal length is necessary for recreating a specific output field profile and the specific focal length is enabled at the dynamic wave-processing device 102 through the static structure 108, then the dynamic wave-processing device 102 is capable of manipulating an input wave field to generate the specific output field profile.

The dynamic wave-processing device 102 can perform directional beamforming to generate one or more output field profiles based on the functional parameters enabled at the dynamic wave-processing device 102. Specifically, the dynamic wave-processing device 102 can manipulate one or more input wave fields to create a directive beam that is focused at either infinity or at a finite length to generate one or more output field profiles through directional beamforming. As will be discussed in greater detail later, the one or more output field profiles can be formed as a continuous trajectory, a quasi-continuous trajectory, or an unstructured point cloud.

Functional parameters enabled at the dynamic wave-processing device 102 can correspond to one or more dimensions in a space, e.g. a multidimensional space. Specifically, functional parameters enabled at the dynamic wave-processing device 102 through the static structure 108 can include a set of directions in either two dimensions or three dimensions. More specifically, the functional parameters can include a set of directions, in either two dimensions or three dimensions, for generating one or more output field profiles through directional beamforming. Further, parameters enabled at the dynamic wave-processing device 102 through the static structure 108 can include a set of focal lengths. Specifically, the functional parameters can include a set of focal lengths for generating one or more output field profiles through directional beamforming. Additionally, parameters enabled at the dynamic wave-processing device 102 through the static structure 108 can include one or more sets of direction and focal length pairs. Specifically, the functional parameters can include a set of direction and focal length pairs for generating one or more output field profiles through directional beamforming.

Further, functional parameters enabled at the dynamic wave-processing device 102 through the static structure 108 can span a multidimensional space formed across the functional parameters. Specifically, a functional parameter of a set of functional parameters enabled at the dynamic wave-processing device 102 can correspond to one or more dimensions in a multidimensional space formed by at least a portion of the set of functional parameters. For example, a first functional parameter can correspond to a focal length in a multidimensional space formed by a set of functional parameters enabled at the dynamic wave-processing device 102. Further in the example, a second functional parameter can correspond to a direction in the multidimensional space formed by the set of functional parameters enabled at the dynamic wave-processing device 102. In another example, first and second functional parameters can correspond to first and second direction angles in a multidimensional space formed by a set of functional parameters enabled at the dynamic wave-processing device 102.

Functional parameters can be simultaneously provided to the dynamic wave-processing device 102, e.g. through the static structure 108. A specific set of functional parameters can be provided to the dynamic wave-processing device 102 so that the functional parameters are dynamically enabled/retrievable/selectable at the dynamic wave-processing device 102 during operation of the dynamic wave-processing device 102. More specifically, one or more functional parameters in the specific set of parameters can be dynamically retrieved at the dynamic wave-processing device to selectively generate one or more specific output field profiles during operation of the dynamic wave-processing device 102. In being simultaneously provided to the dynamic wave-processing device 102, the functional parameters can each be achievable at the dynamic wave-processing device 102 during operation of the wave-processing device 102.

One or more sets of functional parameters can be dynamically enabled at the dynamic wave-processing device 102 through the static structure 108 as part of providing, e.g. simultaneously providing, the one or more sets of functional parameters to the dynamic wave-processing device 102. In being dynamically enabled, the sets of functional parameters can be selected/retrieved at the dynamic wave-processing device 102 during operation of the dynamic wave-processing device 102 to generate specific output field profiles. Specifically, operations of the dynamic wave-processing device 102, e.g. through external sources, can be controlled to select specific functional parameters of the functional parameters enabled at the dynamic wave-processing device 102 to generate specific output field profiles.

Operations of the dynamic wave-processing device 102 can be controlled to iteratively select specific functional parameters at the dynamic wave-processing device 102, e.g. as part of dynamically selecting the specific functional parameters. In particular, the specific functional parameters can be iteratively selected to create one or more specific output field profiles through the dynamic wave-processing device 102, e.g. through directional beamforming. For example, an external source can be controlled to enable/select a first set of functional parameters at the dynamic wave-processing device 102 to generate a first output field profile. Further in the example, the external source can be controlled to switch from the first set of functional parameters and enable/select a second set of functional parameters to generate a second output field profile. Still further in the example, both the first set of functional parameters and the second set of functional parameters can already be provided to the dynamic wave-processing device 102 before they are selected at the dynamic wave-processing device 102.

Functional parameters enabled at the dynamic wave-processing device 102 can be specific to one or more operational frequencies of the dynamic wave-processing device 102, e.g. frequency-encoded at the dynamic wave-processing device 102. In particular, the dynamic wave-processing device 102 can be controlled to operate at a specific operational frequency corresponding to a specific set of functional parameters in order to select/retrieve/enable the specific set of functional parameters at the dynamic wave-processing device 102. One or more operational frequencies specific to one or more functional parameters of the dynamic wave-processing device 102 can be a subset of a plurality of operational frequencies achievable at the dynamic wave-processing device 102. In turn, the operational frequency of the dynamic wave-processing device 102 can be varied to select or otherwise dynamically enable different functional parameters/sets of functional parameters based on the operational frequencies corresponding to the functional parameters/sets of functional parameters. As follows, different output field profiles corresponding to the different functional parameters/sets of functional parameters can be generated by the dynamic wave-processing device 102, e.g. through directional beamforming, by varying the operational frequency of the wave-processing device 102. For example, the dynamic wave-processing device 102 can be controlled to operate at a first operational frequency corresponding to a first set of functional parameters in order to dynamically enable the first set of functional parameters at the dynamic wave-processing device 102. Further in the example, the dynamic wave-processing device 102 can be controlled to switch to a second operational frequency corresponding to a second set of functional parameters to dynamically enable and switch to the second set of functional parameters at the dynamic wave-processing device 102. Still further in the example, different output field profiles corresponding to the first and second sets of functional parameters can be selectively output by the dynamic wave-processing device 102 by switching between the first and second operational frequencies of the dynamic wave-processing device 102 in response to varying the operational frequency.

As an example of dynamically enabling functional parameters at the dynamic wave-processing device 102 according to an operational frequency of the dynamic wave-processing device 102, an oscillatory refractive index n2(f) can be implemented through the artificially-structured material 106. Specifically, the artificially-structured material 106 can include elements, e.g. micro-structured elements, having a series of resonant frequencies f1, f2, etc. More specifically, the artificially-structured material 106 can include a first set of elements having a resonant frequency at or near f1 and a second set of elements having a resonant frequency at or near f2, etc. As follows, the artificially-structured material 106 can provide a refractive index that oscillates as the operating frequency is advanced through each of the successive resonant frequencies f1, f2, etc. Further, the artificially-structured material 106 can also implement a non-oscillatory refractive index n1(f) through elements having resonant frequencies f′ that are all above or below the set of resonant frequencies f1, f2, etc. Accordingly, n1 can change monotonically as the operating frequency is advanced through the set of resonant frequencies f1, f2, etc. While this example is discussed with respect to a single artificially-structured material, a plurality of artificially-structured materials can implement the example technique of dynamically enabling functional parameters according to operational frequency.

An operational frequency of the dynamic wave-processing device 102 can be controlled or otherwise varied through an applicable technique for controlling an operational frequency of the dynamic wave-processing device 102. Specifically, the operational frequency of the dynamic wave-processing device 102 can be varied by varying a carrier frequency of illumination patterns incident on the dynamic wave-processing device 102. As follows, one or more functional parameters can be dynamically enabled at the dynamic wave-processing device 102 by varying the carrier frequency of illumination patterns incident on the dynamic wave-processing device 102. Specifically, the carrier frequency of the illumination patterns incident on the dynamic wave-processing device 102 can be varied to select/enable specific functional parameters at the dynamic wave-processing device 102 and create one or more specific output field profiles.

Additionally, functional parameters can be spatially-encoded at the dynamic wave-processing device 102. Specifically, the functional parameters can be specific to incident illumination patterns based on one or more spatial relationships between the at least a portion of the artificially-structured material 106 encoding the functional parameters and the incident illumination patterns. For example, a functional parameter can be specific to illumination patterns incident to the static structure 108 at a 45° angle. In being spatially-encoded at the dynamic wave-processing device 102, the functional parameters can be selected, or otherwise dynamically enabled, by varying the spatial interactions of incident illumination patterns with respect to the dynamic wave-processing device 102. In turn, one or more output field profiles can be generated through the dynamic wave-processing device 102 by varying the spatial interactions of the incident illumination patterns at the dynamic wave-processing device 102. For example, an incidence angle of illumination patterns at the static structure 108 can be varied to dynamically enable different functional parameters at the dynamic wave-processing device 102. In turn, different output field profiles can be generated through the dynamic wave-processing device 102 by varying the incidence angle of the illumination patterns.

Spatial interactions of incident illumination patterns at the dynamic wave-processing device 102 can be varied through an applicable technique. For example, the dynamic wave-processing device can be mechanically manipulated with respect to a source of incident illumination patterns to vary spatial interactions between the incident illumination patterns and the dynamic wave-processing device 102. In another example, the source of incident illumination patterns can be mechanically manipulated with respect to the dynamic wave-processing device 102 to vary the spatial interactions. Spatial interactions of incident illumination patterns at the dynamic wave-processing device 102 can be varied without individually controlling micro-structured elements of the static structure 108. For example, the entire static structure 108 can be rotated instead of rotating individual micro-structured elements of the static structure 108 in order to vary spatial interactions of incident illumination patterns at the dynamic wave-processing device 102.

The example environment 100 shown in FIG. 1 includes field source(s) 110. The field source(s) 110 are configured to output one or more illumination patterns 112 incident on the dynamic wave-processing device 102. The incident illumination patterns 112 that are generated by the field source(s) 110 can include either or both acoustic field waves or electromagnetic field waves with corresponding carrier frequencies. As follows, the operational frequency of the dynamic wave-processing device 102 can be modulated by varying the carrier frequencies of the incident illumination patterns 112 output by the field source(s) 110. Specifically and when the field source(s) 110 include a plurality of field sources, the carrier frequency of the incident illumination patterns 112 can be adjusted by selectively adjusting an amplitude of each of the plurality of field sources. Alternatively, the carrier frequency of the incident illumination patterns 112 can be adjusted by selectively adjusting a phase of each of the field sources of the plurality of field sources. Additionally, the carrier frequency of the incident illumination patterns 112 can be adjusted by selectively adjusting both a phase and an amplitude of each of the plurality of field sources. Alternatively, when the field source(s) 110 are a single field source, then the single field source can be selectively controlled to modulate the carrier frequency of the incident illumination patterns 112.

The output field profile 104 created by the dynamic wave-processing device 102 can be an unstructured point cloud of radiation points. Specifically, the radiation points forming the output field profile 104 can be created by dynamically enabling specific functional parameters at the dynamic wave-processing device 102. More specifically, the operational frequency of the dynamic wave-processing device 102 can be varied in order to enable specific functional parameters at the dynamic wave-processing device 102 and generate the radiation points forming the unstructured point cloud. For example, the carrier frequency of the incident illumination patterns 112 can be adjusted to enable specific functional parameters at the dynamic wave-processing device 102 and form the radiation points in the unstructured point cloud. Further, spatial interactions of the incident illumination patterns 112 with the dynamic wave-processing device 102 can be adjusted to enable specific functional parameters at the dynamic wave-processing device 102 and form the radiation points in the unstructured point cloud.

Additionally, the output field profile 104 created by the dynamic wave-processing device 102 can be a quasi-continuous trajectory of radiation points. A quasi-continuous trajectory of radiation points can include a plurality of radiation points that in combination cover a portion of the total trajectory. For example, a quasi-continuous trajectory of radiation points can include a plurality of radiation points spaced by 1 mm along a trajectory to form a qausi-continuous trajectory. The radiation points forming the quasi-continuous trajectory of the output field profile 104 can be created by dynamically enabling specific functional parameters at the dynamic wave-processing device 102. More specifically, the operational frequency of the dynamic wave-processing device 102 can be varied in order to enable specific functional parameters at the dynamic wave-processing device 102 and generate the radiation points forming the quasi-continuous trajectory. For example, the carrier frequency of the incident illumination patterns 112 can be adjusted to enable specific functional parameters at the dynamic wave-processing device 102 and form the radiation points in the quasi-continuous trajectory. Further, spatial interactions of the incident illumination patterns 112 with the dynamic wave-processing device 102 can be adjusted to enable specific functional parameters at the dynamic wave-processing device 102 and form the radiation points in the quasi-continuous trajectory.

A quasi-continuous trajectory of radiation points formed by the dynamic wave-processing device 102 can be formed through a meanderline sweeping one or more specific solid angles of a unit sphere. The meanderline can include a plurality of arms and spacing between consecutive arms can match an angle width of a directional beam controlled by the dynamic wave-processing device 102, e.g. through directional beamforming. Further, the quasi-continuous trajectory can be a spiral, e.g. formed by dynamically enabling functional parameters at the dynamic wave-processing device 102. Additionally, the quasi-continuous trajectory can be a Lissajous pattern, e.g. formed by e.g. formed by dynamically enabling functional parameters at the dynamic wave-processing device 102. Also, the quasi-continuous trajectory can be a flower pattern, e.g. formed by dynamically enabling functional parameters at the dynamic wave-processing device 102.

The functional parameters enabled at the dynamic wave-processing device 102 can be enabled as holograms at the dynamic wave-processing device 102. Specifically, the functional parameters can be enabled as holograms at the artificially-structured material 106, e.g. in the static structure 108 of the artificially-structured material 106. As used herein, the term “hologram” refers to a scattering and/or radiating medium, such as an artificially-structured material, which generates a holographic projection when properly excited with a specific illumination pattern. The artificially-structured material 106 can be multi-holographic and store multiple holograms for the functional parameters at the dynamic wave-processing device 102.

Holograms stored at the dynamic wave-processing device 102 can be selectively retrieved to selectively enable functional parameters at the wave-processing device 102. Specifically, holograms stored at the dynamic wave-processing device 102 can be selectively retrieved to create one or more specific output field profiles, e.g. through directional beamforming. Holograms stored at the dynamic wave-processing device 102, e.g. at the artificially-structured material 106, can be either or both frequency-encoded and spatially-encoded. In turn, the artificially-structured material 106 can be either or both a spatially-encoded multi-holographic material and a frequency-encoded multi-holographic material. For example, holograms can be frequency-encoded at the dynamic wave-processing device 102 and retrieved, or otherwise dynamically enabled, by varying the operational frequency of the dynamic wave-processing device 102. In another example, holograms can be spatially-encoded at the dynamic wave-processing device 102 and retrieved, or otherwise dynamically enabled, by varying spatial interactions of incident illumination patterns with respect to the dynamic wave-processing device 102.

A plurality of field sources can be utilized in retrieving holograms that are spatially-encoded and holograms that are frequency-encoded at the dynamic wave-processing device 102. Specifically, a plurality of spatially localized field sources can be positioned at different locations with respect to the dynamic wave-processing device 102 to retrieve different spatially-encoded holograms. More specifically, the plurality of field sources, or switches, can provide a plurality of switchable illumination patterns. Each illumination pattern can retrieve different holograms stored at the dynamic wave-processing device 102 at different frequencies. This can increase the total number of independent holograms that can be dynamically enabled at the dynamic wave-processing device 102 to Nf-by-Ns, where Nf is the number of frequencies used and Ns is the number of spatially localized field sources or switches.

Holograms stored at the dynamic wave-processing device 102 can be iteratively selected/retrieved to create one or more output field profiles. For example, holograms stored at the dynamic wave-processing device 102 can be iteratively selected to form corresponding radiation points in a trajectory of radiation points forming an output field profile. In another example, holograms stored at the dynamic wave-processing device 102 can be iteratively selected to form radiation points in an unstructured point cloud of radiation points forming an output field profile.

Physical design parameters of the dynamic wave-processing device 102 can be selected and implemented to provide/dynamically enable specific functional parameters at the dynamic wave-processing device 102. In particular, physical design parameters can be selected and implemented at the dynamic wave-processing device 102 to dynamically enable holograms corresponding to a specific set of functional parameters at the dynamic wave processing device 102. More specifically, physical design parameters can be selected to create holograms at the dynamic wave-processing device 102. In turn, the dynamic wave-processing device 102 can be fabricated according to the selected physical design parameters to store, or otherwise dynamically enable, the holograms at the dynamic wave-processing device 102. As will be discussed in greater detail later, physical design parameters of the dynamic wave-processing device 102 can be selected according to one or more applicable techniques for selecting physical design parameters in order to dynamically enable one or more specific functional parameters at the dynamic wave-processing device 102.

Physical design parameters can include applicable parameters of the dynamic wave-processing device 102 that remain unchanged during operation of the dynamic wave-processing device 102. Specifically, physical design parameters at the dynamic wave-processing device 102 can include static design parameters of the static structure 108 of the artificially-structured material 106 that remain unchanged during operation of the dynamic wave-processing device 102. For example, physical design parameters of the dynamic wave-processing device 102 can include electromagnetic and/or acoustic characteristics of elements of the static structure 108 that remain unchanged during operation of the dynamic wave-processing device 102. In another example, physical design parameters include sizes of elements of the static structure 108 and spacing between the elements of the static structure 108 that remain unchanged during operation of the dynamic wave-processing device 102. In yet another example, physical design parameters can include locations of elements to form the static structure 108 of the artificially-structured material 106.

Further, physical design parameters can include adjustable control inputs for the dynamic wave-processing device 102. Specifically, physical design parameters can include adjustable control input for controlling operation of the static structure 108 of the dynamic wave-processing device 102. In turn, the dynamic wave-processing device 102 can be controlled according to the adjustable control inputs defined by the physical design parameters to dynamically enable one or more functional parameters at the dynamic wave-processing device 102. Specifically, the dynamic wave-processing device 102 can be controlled according to the adjustable control inputs defined by the physical design parameters to store one or more holograms corresponding to one or more functional parameters at the dynamic wave-processing device 102.

Physical design parameters can include design parameters of micro-structured elements forming the artificially-structured material 106. Specifically, physical design parameters can include design parameters of micro-structured elements forming the static structure 108 of the artificially-structured material 106. For example, physical design parameters of the micro-structured elements can define physical locations of the micro-structured elements in forming the artificially-structured material 106. The physical design parameters of the micro-structured elements forming the artificially-structured material 106 can be selected and implemented to provide/dynamically enable specific functional parameters through the micro-structured elements. For example, micro-structured elements can be selectively positioned to enable one or more specific functional parameters at the artificially-structured material 106.

Two or more micro-structured elements forming the artificially-structured material 106 can have different physical properties that distinguish the micro-structured elements from each other. Specifically, each of the micro-structured elements forming the artificially-structured material 106 can have different physical properties that distinguish the micro-structured elements from each other. For example, the micro-structured elements can have different structural shapes that distinguish the micro-structured elements from each other. In another example, the micro-structured elements can have different electromagnetic and/or acoustic properties that distinguish the micro-structured elements from each other.

Each of the micro-structured elements can correspond to a hologram of a plurality of holograms dynamically enabled at the dynamic wave-processing device 102. In turn, operation of the dynamic wave-processing device 102 can be controlled to dynamically enable specific holograms corresponding to each of the micro-structured elements. Physical design parameters can be selected for each of the micro-structured elements to dynamically enable holograms corresponding to the micro-structured elements at the dynamic wave-processing device 102. For example, electromagnetic properties of a micro-structured element can be selected and implemented to dynamically enable a specific hologram through the micro-structured element at the dynamic wave-processing device 102.

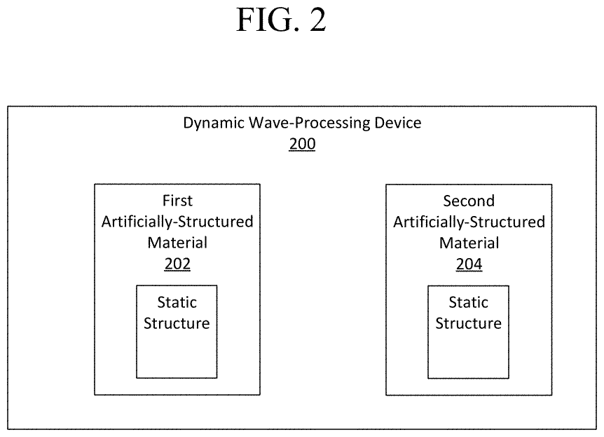

FIG. 2 illustrates an example dynamic wave-processing device 200. The dynamic wave-processing device 200 can function according to an applicable device for generating one or more specific output field profiles, such as the dynamic wave-processing device 102 in the example environment 100 shown in FIG. 1. In particular, the dynamic wave-processing device 200 can include a plurality of functional parameters enabled at the dynamic wave-processing device 200. As follows, the functional parameters can be dynamically enabled/selected during operation of the dynamic wave-processing device 200 to generate one or more specific output field profiles corresponding to the functional parameters. More specifically, physical design parameters of the dynamic wave-processing device 200 can be selected and implemented to enable the creation of one or more specific output field profiles through the dynamic wave-processing device 200.

The dynamic wave-processing device 200 includes a first artificially-structured material 202 and a second artificially-structured material 204. Both the first and second artificially-structured materials 202 and 204 can have functional parameters, e.g. different functional parameters, enabled at the artificially-structured materials 202 and 204. Specifically, both the first and second artificially-structured materials 202 and 204 can include corresponding static structures that dynamically enable specific functional parameters at the first and second artificially-structured materials 202 and 204. More specifically, both the first and second artificially-structured materials 202 and 204 can be formed through micro-structured elements that dynamically enable one or more functional parameters, e.g. store holograms, at the first and second artificially-structured materials 202 and 204.

Functional parameters can be enabled at the first and second artificially-structured materials 202 and 204 based on physical design parameters for the dynamic wave-processing device 200, e.g. physical design parameters for the first and second artificially-structured materials 202 and 204. Specifically, both the first and second artificially-structured materials 202 and 204 can have engineered frequency dispersions based on selected physical design parameters to provide a specific set of functional parameters at the dynamic wave-processing device 200. For example, static electromagnetic and/or acoustic properties of micro-structured elements forming the first and second artificially-structured materials 202 and 204 can be selected and implemented to provide a specific set of functional parameters at the dynamic wave-processing device 200.

Additionally, functional parameters enabled at the first and second artificially-structured materials 202 and 204 can be selected, e.g. dynamically enabled, during operation of the dynamic wave-processing device 200 through an applicable technique. Specifically, functional parameters enabled at the first and second artificially-structured materials 202 and 204 can be selected by varying an operational frequency of the dynamic wave-processing device 200. For example, a carrier frequency of illumination patterns incident to the dynamic wave-processing device 200 can be varied to dynamically enable one or more functional parameters in either or both the first artificially-structured material 202 and the second artificially-structured material 204. Further, functional parameters enabled at the first and second artificially-structured materials 202 and 204 can be selected by varying spatial interactions of incident illumination patterns with either or both the first and second artificially-structured materials 202 and 204.

While the first and second artificially-structured materials 202 and 204 are shown as conceptually separate in the dynamic wave-processing device 200, the first and second artificially-structured materials 202 and 204 can be disposed within the dynamic wave-processing device 200 such that the materials 202 and 204 interact with each other. Specifically, both the first and second artificially-structured materials 202 and 204 can be formed by two layers of materials that are disposed within the dynamic wave-processing device 200 to form stacked artificially-structured material layers. In interacting with each other, the first and second artificially-structured materials 202 and 204 can function together to process one or more wave fields and generate one or more specific output field profiles. In particular, specific functional parameters can be dynamically enabled at the first and second artificially-structured materials 202 and 204 to generate one or more specific output field profiles from one or more wave fields interacting with both the first and second artificially-structured materials 202 and 204.

The first and second artificially-structured materials 202 and 204 can be implemented as separate prisms, e.g. prism layers. Specifically, the first and second artificially-structured materials 202 and 204 can be implemented as prisms having different refractive characteristics. For example, the first artificially-structured material 202 can be a metamaterial prism with a spatially-uniform effective refractive index n1(f). n1(f) can be a monotonic function of frequency, gradually increasing (or decreasing) over an entire allocated frequency band, e.g. a frequency band associated with the dynamic wave-processing device 200. Further in the example, the second artificially-structured material 204 can be a different metamaterial prism with a spatially-uniform effective refractive index n2(f). n2(f) can be an oscillatory (but not necessarily periodic) function of frequency, having multiple maxima and minima over the entire allocated frequency band. Still further in the example, the first and second artificially-structured materials 202 and 204 can provide angular deflection in two orthogonal planes. As a result, quasi-continuous beam steering can be achieved at the dynamic wave-processing device with nearly full control over the two angular degrees of freedom of the beam.

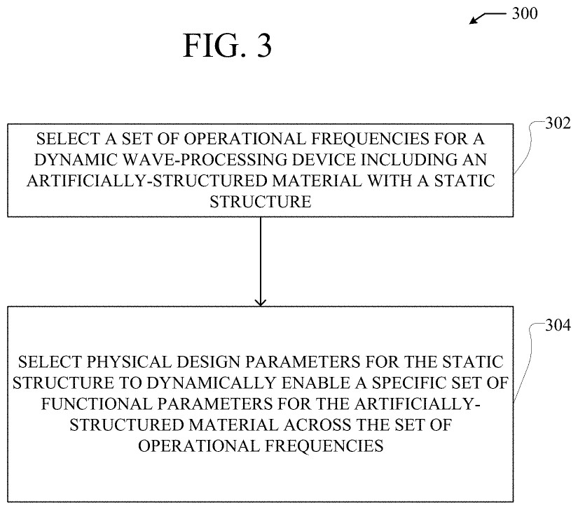

FIG. 3 is a flowchart 300 of an example method of selecting physical design parameters for a dynamic wave-processing device to dynamically enable a set of functional parameters at the device.

At step 302, a set of operational frequencies for a dynamic wave-processing device are selected. The dynamic wave-processing device can include one or more artificially-structured materials. Each of the one or more artificially-structured materials included as part of the dynamic wave-processing device can include a static structure. The dynamic wave-processing device can function according to an applicable device for generating one or more output field profiles from one or more waveforms, such as the dynamic wave-processing devices described herein.

At step 304, physical design parameters for the dynamic wave-processing device can be selected to dynamically enable a specific set of functional parameters for the dynamic wave-processing device. Specifically, physical design parameters for the static structure of the artificially-structured material can be selected to dynamically enable the specific set of functional parameters for the artificially-structured material across the set of selected operational frequencies. The specific set of functional parameters can correspond to one or more output field profiles that are achievable through the dynamic wave-processing device by dynamically enabling at least a subset of the set of functional parameters during operation of the dynamic-wave processing device.

The physical design parameters can be selected through a computational artificial intelligence (AI) process. An applicable AI process can be applied to select the physical design parameters for the dynamic wave-processing device. Further the physical design parameters can be selected through a machine learning (ML process), an applicable ML process can be applied to select the physical design parameters of the dynamic wave-processing device. For example, one or a combination of a deep learning (DL) process, a neural network (NN) process, a deep neural network (DNN) process, a convolutional neural network (CNN) process, a long short-term memory (LSTM) network process, a generative adversarial network (GAN) process, a variational autoencoder (VAE) process, a principal component analysis (PCA) process, a support vector machine (SVM) process, a clustering process, and a generative modeling process can be applied to select the physical design parameters. Using either or both AI and ML processes to select the physical design parameters of the dynamic wave-processing device provides numerous advantageous. For example, AI and/or ML techniques can be utilized to minimize the number of expensive factorizations required to reach a certain convergence criterion in the design of the dynamic wave-processing device, e.g. a multi-holographic artificially-structured material of the dynamic wave-processing device.

A ML process used in selecting the physical design parameters can be based on learning features of one or more objective functions. An objective function can include an applicable goal or result to achieve during operation of the dynamic wave-processing device. For example, an objective function can include generating a specific output field profile within a set of operational frequencies, e.g. the set of operational frequencies selected at step 302.

In applying a ML process based on one or more objective functions, a pattern of one or more local optima of the one or more objective functions can be identified/learned. In turn, the physical design parameters can be selected by applying the ML process based on the pattern of the one or more local optima of the one or more objective functions. Specifically, an estimator function that estimates the locations of the one or more local optima can be generated using a training set of the one or more local optima and a set of tunable fitting parameters. Additionally, new local minima of the one or more objective functions can be predicted and accurate locations of the new local minima can be identified based on the predictions of the new local minima. As follows, the training set of the one or more local optima can be expanded based on the new local minima and the locations of the new local minima to generate a new training set of the one or more local optima. In turn, the estimator function and the corresponding tunable fitting parameters of the estimator function can be dynamically updated based on the new training set to learn the pattern of the one or more local optima of the one or more objective functions.

All or an applicable portion of the previously described steps with respect to applying a ML process based on one or more objective functions can be repeated. Specifically, the steps of predicting new local minima, finding accurate locations of the new local minima, expanding the training set based on the new local minima and the locations of the new local minima, and dynamically updating the estimator function based on the new training set can be repeated until one or more specific performance conditions are satisfied. A performance condition can include an applicable optimization goal or objective function related to operation of the dynamic wave-processing device. For example, the previously described steps can be repeated until one or more physical design parameters are selected that allow the dynamic wave-processing device to process specific input waveforms into one or more specific output field profiles.

The physical design parameters for the dynamic wave-processing device can be selected with an optimization process. The optimization process can be a global optimization process with a fixed cost function, e.g. an objective function, fitness function, merit function, that can have constraints that reflect the limitations of a particular manufacturing technique. Specifically, the global optimization process can be an evolutionary or genetic process. Further the global optimization process can be based on a dynamically updated surrogate objective function, e.g. for the dynamic wave-processing device. The surrogate objective function can by dynamically constructed based on previously learned objective values, e.g. for the dynamic wave-processing device or another applicable dynamic wave-processing devices. Specifically, the surrogate objective function can be dynamically constructed from a multidimensional interpolation function based on previously learned objective values. Additionally, the surrogate objective function can be dynamically constructed gradients of an objective function where previously learned objective values are learned. Further, the surrogate objective function can be dynamically constructed from Hessians of an objective function at points where the previously learned objective values are learned.

An optimization process used in selecting the physical design parameters for the dynamic wave-processing device can be a multi-objective optimization process. Specifically, the physical design parameters can be selected based on a vector of different objectives rather than a single objective. The multi-objective optimization process can be a Pareto search-based process, an evolutionary process, or a genetic process. Further, the multi-objective optimization process can include multiple components corresponding to estimates of at least on functional metric associated with the dynamic wave-processing device. Specifically, the multi-objective optimization process can include multiple components corresponding to estimates for enabling one or more functional parameters at the dynamic wave-processing device, e.g. within the selected set of operational frequencies.

Further, the optimization process used in selecting the physical design parameters for the dynamic wave-processing device can include multiple objectives condensed into a single objective function. The objectives can be condensed into a single object functions using an applicable technique, e.g. through a weighted aggregation formula. Additionally, the optimization process can include an optimization objective that is a function of field intensities calculated at different locations with respect to the dynamic wave-processing devices. Further, the optimization process can include an optimization objective that is a function of field intensities calculated at different frequencies with respect to operation of the dynamic wave-processing devices.

Also, the optimization process can include an optimization goal to maximize a spatial extent of a spatial domain where field intensities measured relative to a reference field intensity exceed a specific threshold. The spatial extent can be measured as a Euclidean volume of the spatial domain where the field intensities exceed the specific threshold. Further, the spatial extent can be measured as a surface area on a 2D manifold where the field intensities exceed the specific threshold. The 2D manifold can intersect the spatial domain where the field intensities are created.

Additionally, the optimization process can be an integer variable optimization process. The integer variable optimization process can be a Boolean-variable, binary variable, optimization process. Further, the optimization process can be a stochastic or statistical optimization process. The stochastic or statistical optimization process can be a Bayesian optimization process. Also, the optimization process can be a gradient-based optimization process. The gradient-based optimization process can include gradient calculations by an adjoint method. Further, the optimization process can be a gradient- and Hessian-based optimization process. The gradient- and Hessian-based optimization process can be a quadratic programming solver. The gradient- and Hessian-based optimization process can also include gradient and Hessian calculations by a second-order extended adjoint technique.

The specific set of functional parameters can be selected and/or enabled based on predictions of values of one or more functional parameters of the specific set of functional parameters for the dynamic wave-processing device. The predictions of values of the one or more functional parameters can be made for at least one trial configuration of the dynamic wave-processing device. Specifically, the predictions of values of the one or more functional parameters can be made through a machine learning process previously trained on one or more trial configurations of the dynamic wave-processing device. The one or more predicted functional parameters can include at least one functional parameter of the dynamic wave-processing device likely to maximize at least one functional parameter of the dynamic wave-processing device with respect to a desired performance of the dynamic wave-processing device, e.g. a specific output field profile generated by the dynamic wave-processing device. Additionally, the specific set of functional parameters can be enabled through one or more predictions of a subset of the set of functional parameters that are likely to be maximized to a specific overall performance with respect to a desired performance of the dynamic wave-processing device. The specific overall performance can be a weighted sum of the subset of the set of functional parameters. The predictions of the subset of the set of functional parameters can be generated through a machine learning process, e.g. a machine learning process previously trained on one or more trial configurations of the dynamic wave-processing device.

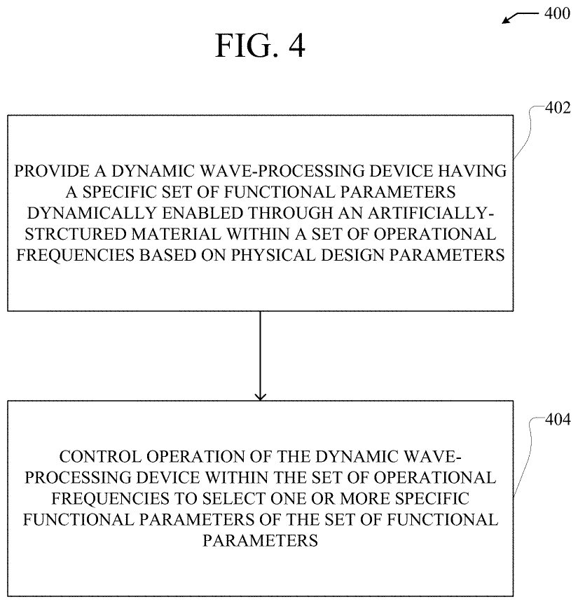

FIG. 4 is a flowchart 400 of an example method of controlling a dynamic wave-processing device to select one or more specific functional parameters dynamically enabled at the dynamic wave-processing device. At step 402, a dynamic wave-processing device is provided. The dynamic wave-processing device has a specific set of functional parameters dynamically enabled through one or more artificially-structured materials. The set of functional parameters can be enabled at the dynamic wave-processing device within a set of operational frequencies based on physical design parameters selected for the dynamic wave-processing device. Specifically, the set of functional parameters can be dynamically enabled at the dynamic wave-processing device through one or more static structures included as part of the one or more artificially-structured materials based on the physical design parameters. The dynamic wave-processing device can function according to an applicable device for generating one or more output field profiles from one or more waveforms, such as the dynamic wave-processing devices described herein.

At step 404, operation of the dynamic wave-processing device is controlled within the set of operational frequencies to select one or more specific functional parameters of the set of functional parameters. Specifically, operation of the dynamic wave-processing device can be controlled to select one or more specific functional parameters and generate one or more specific output field profiles. In controlling operation of the dynamic wave-processing device, an operational frequency of the dynamic-wave processing device can be varied to select one or more specific functional parameters in the set of functional parameters. For example, a carrier frequency of incident illumination patterns at the dynamic wave-processing device can be varied in order to vary the operational frequency of the dynamic wave-processing device. Further, in controlling operation of the dynamic wave-processing device, spatial interactions of the incident illumination patterns with the dynamic wave-processing device, e.g. the static structure(s) of the artificially-structured material(s) of the dynamic wave-processing device, can be modified to select one or specific functional parameters in the set of functional parameters.

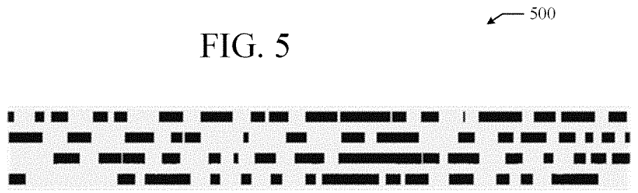

FIG. 5 is a cross-sectional view of an artificially-structured material 500 of a dynamic wave-processing device. The artificially-structured material 500 can be a rotationally symmetric three-dimensional structure. The dynamic wave-processing device can be a directional acoustic beamforming device. The artificially-structured material 500 shown in FIG. 5 is engineered to store a plurality of functional parameters that are dynamically enabled at the dynamic wave-processing device. Specifically, the artificially-structured material 500 is engineered to provide varying first and second focal lengths at respective first and second frequencies. In the artificially-structured material 500 shown in FIG. 5, the black areas represent solid/material parts of the artificially-structured material 500 while the other areas represent fluid areas, e.g. areas through which waves can propagate.

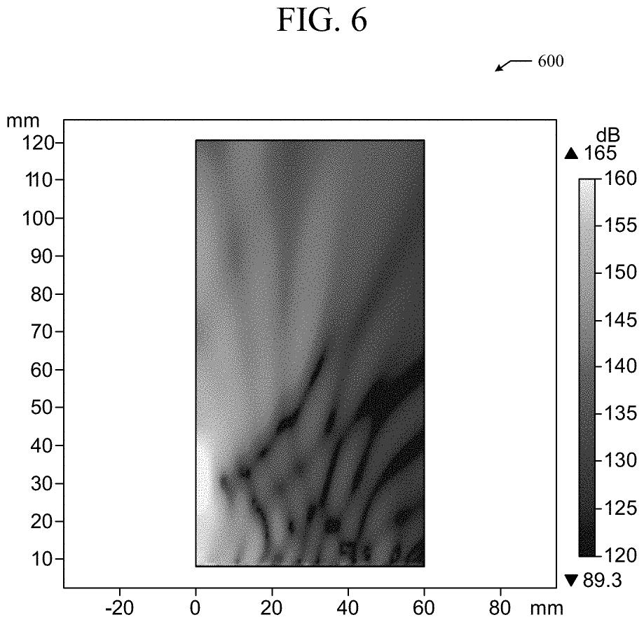

FIG. 6 shows an example output field profile 600 created through the artificially-structured material 500 shown in FIG. 5. The field profile 600 shown in FIG. 6 is generated at an operational frequency of 38 kHz. Further, the field profile 600 shown in FIG. 6 has a focal length of around 30 mm.

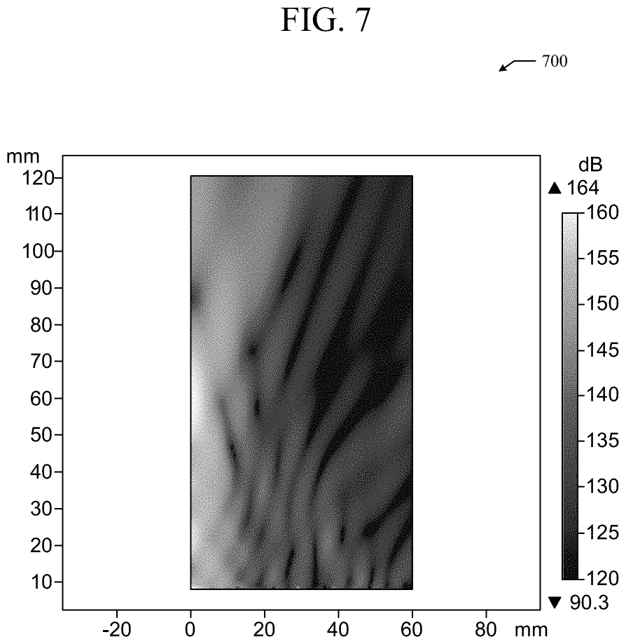

FIG. 7 shows another example output field profile 700 created through the artificially-structured material 500 shown in FIG. 5. The field profile 700 shown in FIG. 7 is generated at an operational frequency of 42 kHz. Further, the field profile 700 shown in FIG. 7 has a focal length of around 60 mm.

This disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. A method, comprising:
selecting a set of operational frequencies for a dynamic wave-processing device comprising at least in part a metamaterial with a static structure; and
selecting physical design parameters for the static structure of the metamaterial as part of the dynamic wave-processing device to dynamically enable a specific set of functional parameters for the metamaterial across the set of operational frequencies.

2. (canceled)

3. The method of claim 1, wherein the metamaterial is a frequency-encoded multi-holographic metamaterial.

4. The method of claim 1, wherein the metamaterial is a spatially-encoded multi-holographic metamaterial.

5. The method of claim 1, wherein the metamaterial is a hybrid frequency-spatially-encoded multi-holographic metamaterial.

6-9. (canceled)

10. The method of claim 1, wherein the one or more functional parameters are simultaneously provided to the dynamic wave-processing device and each of the one or more functional parameters is achievable during operation of the dynamic wave-processing device based on an operational frequency of the dynamic wave-processing device operating the set of operational frequencies.

11. The method of claim 1, wherein the physical device parameters are selected, at least in part, with a computational artificial intelligence (Al) process.

12. The method of claim 1, wherein the physical device parameters are selected, at least in part, with a machine learning (ML) process.

13-16. (canceled)

17. The method of claim 12, wherein selecting with the ML process includes selecting with one or more of a deep learning (DL) process, a neural network (NN) process, a deep neural network (DNN) process, a convolutional neural network (CNN) process, a long short-term memory (LSTM) network process, a generative adversarial network (GAN) process, a variational autoencoder (VAE) process, a principal component analysis (PCA) process, a support vector machine (SVM) process, a clustering process, and a generative modeling process.

18. The method of claim 1, wherein the physical device parameters are selected with an optimization process.

19-42. (canceled)

43. The method of claim 1, further comprising:
identifying one or more predictions of values of at least one of the one or more functional parameters for at least one trial configuration of the dynamic wave-processing device through a machine learning process previously trained on one or more trial configurations of the dynamic wave-processing device; and
enabling the specific set of functional parameters through the one or more predictions of values of the at least one of the one or more functional parameters.

44. The method of claim 1, further comprising:
identifying, through a machine learning process previously trained on one or more trial configurations of the dynamic wave-processing device, one or more predictions of values of at least one of the one or more functional parameters that are likely to maximize at least one functional parameter of the dynamic wave-processing device with respect to a desired performance of the dynamic wave-processing device; and
enabling the specific set of functional parameters through the one or more predictions of values of the at least one of the one or more functional parameters.

45. The method of claim 1, further comprising enabling the specific set of functional parameters through one or more predictions of a subset of the specific set of functional parameters, wherein the subset of the specific set of functional parameters includes one or more functional parameters of the dynamic wave-processing device likely to be maximized to a specific overall performance with respect to a desired performance of the dynamic wave-processing device by the subset of the specific set of functional parameters.

46. The method of claim 45, wherein the specific overall performance is a weighted sum of the subset of the specific set of functional parameters.

47. The method of claim 45, wherein the one or more predictions are produced by a machine learning process previously trained on one or more trial configurations of the dynamic wave-processing device.

48. The method of claim 1, wherein the dynamic wave-processing device is a directional beamforming device.

49. The method of claim 48, wherein the specific set of functional parameters is a set of directions in either two or three dimensions for directional beamforming.

50. The method of claim 48, wherein the specific set of functional parameters is a set of focal lengths for directional focused beamforming.

51. The method of claim 48, wherein the specific set of functional parameters is a set of direction and focal length pairs for directional focused beamforming.

52-80. (canceled)

81. The method of claim 1, wherein the dynamic wave-processing device includes a first metamaterial layer and a second metamaterial layer that are disposed within the dynamic wave-processing device to form stacked metamaterial layers.

82. The method of claim 81, wherein the first metamaterial layer and the second metamaterial layer have engineered frequency dispersions based on the physical design parameters to provide the specific set of functional parameters for the dynamic wave-processing device.

83. The method of claim 81, wherein the first metamaterial layer is a first metamaterial prism layer and the second metamaterial layer is a second metamaterial prism layer having different refractive characteristics than the first metamaterial prism layer.

84. The method of claim 83, wherein the first metamaterial layer has a spatially-uniform effective refractive index that is a monotonic function of the operational frequency over the set of operational frequencies and the second metamaterial layer has a spatially-uniform effective refractive index that is an oscillatory function of the operational frequency over the set of operational frequencies.

85-86. (canceled)

87. An apparatus, comprising:
a dynamic wave-processing device having a specific set of functional parameters corresponding to a set of operational frequencies of the dynamic wave-processing device that are dynamically enabled through a metamaterial with a static structure of the dynamic wave-processing device within the set of operational frequencies, wherein the set of functional parameters are enabled in the dynamic wave-processing device based on physical design parameters for the static structure of the metamaterial that are selected for enabling the set of functional parameters.

88. (canceled)

89. The apparatus of claim 87, wherein the metamaterial is a frequency-encoded multi-holographic metamaterial.

90. The apparatus of claim 87, wherein the metamaterial is a spatially-encoded multi-holographic metamaterial.

91. The apparatus of claim 87, wherein the metamaterial is a hybrid frequency-spatially-encoded multi-holographic metamaterial.

92-95. (canceled)

96. The apparatus of claim 87, wherein the one or more functional parameters are simultaneously provided to the dynamic wave-processing device and each of the one or more functional parameters is achievable during operation of the dynamic wave-processing device based on an operational frequency of the dynamic wave-processing device operating the set of operational frequencies.

97. The apparatus of claim 87, wherein the physical device parameters are selected, at least in part, with a computational artificial intelligence (Al) process.

98. The apparatus of claim 87, wherein the physical device parameters are selected, at least in part, with a machine learning (ML) process.

99-103. (canceled)

104. The apparatus of claim 87, wherein the physical device parameters are selected with an optimization process.

105-128. (canceled)

129. The apparatus of claim 87, wherein the specific set of functional parameters are enabled by:
identifying one or more predictions of values of at least one of the one or more functional parameters for at least one trial configuration of the dynamic wave-processing device through a machine learning process previously trained on one or more trial configurations of the dynamic wave-processing device; and
enabling the specific set of functional parameters through the one or more predictions of values of the at least one of the one or more functional parameters.

130. The apparatus of claim 87, wherein the specific set of functional parameters are enabled by:
identifying, through a machine learning process previously trained on one or more trial configurations of the dynamic wave-processing device, one or more predictions of values of at least one of the one or more functional parameters that are likely to maximize at least one functional parameter of the dynamic wave-processing device with respect to a desired performance of the dynamic wave-processing device; and
enabling the specific set of functional parameters through the one or more predictions of values of the at least one of the one or more functional parameters.

131. The apparatus of claim 87, wherein the specific set of functional parameters are enabled through one or more predictions of a subset of the specific set of functional parameters and the subset of the specific set of functional parameters includes one or more functional parameters of the dynamic wave-processing device likely to be maximized to a specific overall performance with respect to a desired performance of the dynamic wave-processing device by the subset of the specific set of functional parameters.

132. The apparatus of claim 131, wherein the specific overall performance is a weighted sum of the subset of the specific set of functional parameters.

133. The apparatus of claim 131, wherein the one or more predictions are produced by a machine learning process previously trained on one or more trial configurations of the dynamic wave-processing device.

134. The apparatus of claim 87, wherein the dynamic wave-processing device is a directional beamforming device.

135. The apparatus of claim 134, wherein the specific set of functional parameters is a set of directions in either two or three dimensions for directional beamforming.

136. The apparatus of claim 134, wherein the specific set of functional parameters is a set of focal lengths for directional focused beamforming.

137. The apparatus of claim 134, wherein the specific set of functional parameters is a set of direction and focal length pairs for directional focused beamforming.

138-166. (canceled)

167. The apparatus of claim 87, wherein the dynamic wave-processing device includes a first metamaterial layer and a second metamaterial layer that are disposed within the dynamic wave-processing device to form stacked metamaterial layers.

168. The apparatus of claim 167, wherein the first metamaterial layer and the second metamaterial layer have engineered frequency dispersions based on the physical design parameters to provide the specific set of functional parameters for the dynamic wave-processing device.

169. The apparatus of claim 167, wherein the first metamaterial layer is a first metamaterial prism layer and the second metamaterial layer is a second metamaterial prism layer having different refractive characteristics than the first metamaterial prism layer.

170. The apparatus of claim 169, wherein the first metamaterial layer has a spatially-uniform effective refractive index that is a monotonic function of the operational frequency over the set of operational frequencies and the second metamaterial layer has a spatially-uniform effective refractive index that is an oscillatory function of the operational frequency over the set of operational frequencies.

171-261. (canceled)
